(19) United States
(12) Patent Application Publication
(10) Pub. No.: US 2026/0116394 A1
(43) Pub. Date: Apr. 30, 2026

(54) TRAVELLING STATE PREDICTION APPARATUS, TRAVELLING STATE PREDICTION METHOD AND PROGRAM THEREOF

(71) Applicant: DENSO CORPORATION, Kariya-city (JP)

(72) Inventors: Yuki YAMAZAKI, Kariya-city (JP); Hiroyuki NANJO, Kariya-city (JP)

(73) Assignee: DENSO CORPORATION, Kariya-city (JP)

(21) Appl. No.: 19/003,467

(22) Filed: Dec. 27, 2024

(30) Foreign Application Priority Data
Jan. 17, 2024 (JP) 2024-005333

(51) Int. Cl. B60W 40/105; B60W 50/00

(52) U.S. Cl. CPC B60W 40/105; B60W 50/0097; B60W 2520/10; B60W 2556/10

(57) ABSTRACT

A travelling state prediction apparatus that predicts a travelling state of an own vehicle is provided with a moving speed acquiring unit and a deceleration location prediction unit. The moving speed acquiring unit acquires speed result information as information related to a result of a moving speed of one or more vehicles. The deceleration location prediction unit predicts a deceleration location of the own vehicle based on the acquired speed result information. A method of predicting a travelling state of an own vehicle is a method of predicting a travelling state of the own vehicle accomplished by acquiring speed result information and predicting a deceleration location of the own vehicle based on the acquired speed result information. A travelling state prediction program includes a moving speed acquiring process and a deceleration location prediction process that predicts a deceleration location of the own vehicle.

### CROSS-REFERENCE TO RELATED APPLICATION

This application is based on and claims the benefit of priority from earlier Japanese Patent Application No. 2024-5333 filed Jan. 17, 2024, the description of which is incorporated herein by reference.

### BACKGROUND

### Technical Field

The present disclosure relates to a traveling state prediction apparatus, a traveling state predicting method and a travelling state prediction program for predicting a travelling state of the own vehicle.

### Description of the Related Art

As a related art, a vehicle energy consumption prediction apparatus, a vehicle energy consumption prediction method and a computer program thereof are known which are for predicting an energy consumption consumed by a driving source of a vehicle, taking a travelling mode of the vehicle when travelling through an intersection into consideration. Specifically, a vehicle energy consumption prediction apparatus including route identifying means and energy consumption prediction means is provided with intersection identifying means, speed limit acquiring means and acceleration prediction means.

### SUMMARY

A travelling state prediction apparatus according to a first aspect is provided with a moving speed acquiring unit that acquires speed result information as information related to a result of a moving speed of one or more vehicles; and a deceleration location prediction unit that predicts a deceleration location of the own vehicle based on the acquired speed result information. A travelling state prediction method according to a tenth aspect is a method of predicting a travelling state of the own vehicle accomplished by acquiring speed result information as information related to a result of a moving speed of one or more vehicles and predicting a deceleration location of the own vehicle based on the acquired speed result information. A travelling state prediction program according to an eleventh aspect is a computer program executed by a travelling state prediction apparatus that predicts a travelling state of an own vehicle, including a moving speed acquiring process that acquires speed result information as information related to a result of a moving speed of one or more vehicles; and a deceleration location prediction process that predicts a deceleration location of the own vehicle based on the acquired speed result information.

### BRIEF DESCRIPTION OF THE DRAWINGS

The above-described objects and other objects, features and advantages of the present disclosure will be clarified further by the following detailed description with reference to the accompanying drawings. The drawings are:

FIG. 1 is a block diagram showing an overall configuration of a system provided with a travelling state prediction apparatus according to an embodiment of the present disclosure;

FIG. 2 is a schematic diagram illustrating an overall operation of the travelling state prediction apparatus shown in FIG. 1;

FIG. 3 is a block diagram showing an overall functional configuration of a moving speed calculation function shown in FIG. 1;

FIG. 4 is a block diagram showing an overall functional configuration of a target speed determination function provided in the travelling state prediction apparatus according to the first embodiment shown in FIG. 1;

FIG. 5 is a flowchart showing an overall operation of the travelling state prediction apparatus according to the first embodiment;

FIG. 6 is a graph showing an overall operation of the travelling state prediction apparatus according to the first embodiment;

FIG. 7 is a graph showing an overall operation of the travelling state prediction apparatus according to the first embodiment;

FIG. 8 is a block diagram showing an overall functional configuration of a target speed determination function provided in a travelling state prediction apparatus shown in FIG. 1 according to a second embodiment;

FIG. 9 is a flowchart showing an overall operation of the travelling state prediction apparatus according to the second embodiment;

FIG. 10 is a graph showing an overall operation of the travelling state prediction apparatus according to the second embodiment;

FIG. 11 is a graph showing an overall operation of the travelling state prediction apparatus according to the second embodiment;

FIG. 12 is a graph showing an overall operation of the travelling state prediction apparatus according to the second embodiment;

FIG. 13 is a block diagram showing an overall functional configuration of a target speed determination function provided in a travelling state prediction apparatus shown in FIG. 1 according to a third embodiment;

FIG. 14 is a flowchart showing an overall operation of the travelling state prediction apparatus according to a third embodiment;

FIG. 15 is a graph showing an overall operation of the travelling state prediction apparatus according to the third embodiment;

FIG. 16 is a graph showing an overall operation of the travelling state prediction apparatus according to the third embodiment; and

FIG. 17 is a graph showing an overall operation of the travelling state prediction apparatus according to the third embodiment; and

### DETAILED DESCRIPTION OF THE PREFERRED EMBODIMENTS

As a related art, for example, JP-A-2009-67350 discloses a vehicle energy consumption prediction apparatus, a vehicle energy consumption prediction method and a computer program thereof for predicting an energy consumption consumed by a driving source of a vehicle, taking a travelling mode of the vehicle when travelling through an intersection into consideration. Specifically, a vehicle energy consumption prediction apparatus including route identifying means and energy consumption prediction means is provided with intersection identifying means, speed limit acquiring means and acceleration prediction means.

The route identifying means identifies a scheduled travelling route of the vehicle. The energy consumption prediction means predicts an energy consumption which is consumed by a driving source that produces a driving force of a vehicle when travelling through a scheduled travelling route identified by the route identifying means. The intersection identifying means identifies an intersection on the scheduled travelling route. The speed limit acquiring means acquires a speed limit of a road connecting to the intersection identified by the intersection identifying means. The acceleration prediction means predicts, based on the speed limit acquired by the speed limit acquiring means and a predetermined acceleration, an acceleration time of a vehicle when the vehicle travels through the intersection. The energy consumption prediction means predicts an energy consumption based on the acceleration time of the vehicle predicted by the acceleration prediction means.

According to a technique disclosed by the above-described patent literature, an energy consumption due to an acceleration resistance when the vehicle travels through the intersection can be predicted. However, a probability of stoppage of the vehicle in the intersection is not widely available as traffic information. Hence, the technique disclosed in the above-described patent literature is performed only in a limited environment.

### Embodiments

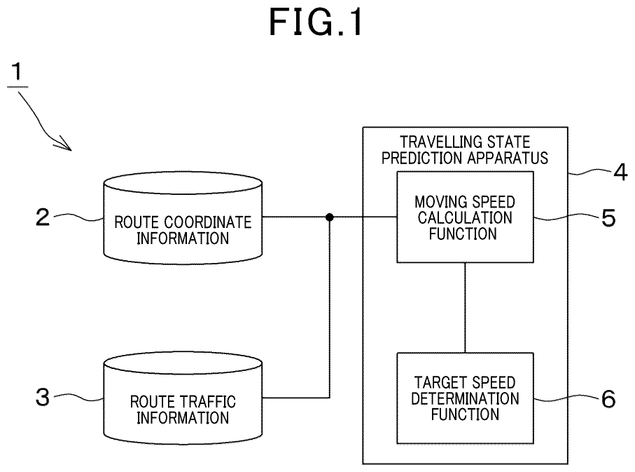

Hereinafter, exemplary embodiments and specific examples of the present disclosure will be described with reference to the drawings. Firstly, with reference to FIGS. 1 to 3, an overall configuration of a system 1 which is applicable to a vehicle travelling on a road will be described. Note that the vehicle to which the system 1 is applied, that is, a vehicle provided with all of or some of the elements of the system 1 is referred to as an own vehicle. As shown in FIG. 1, the system 1 is provided with route coordinate information 2, route coordinate information 3 and a traveling state prediction apparatus 4.

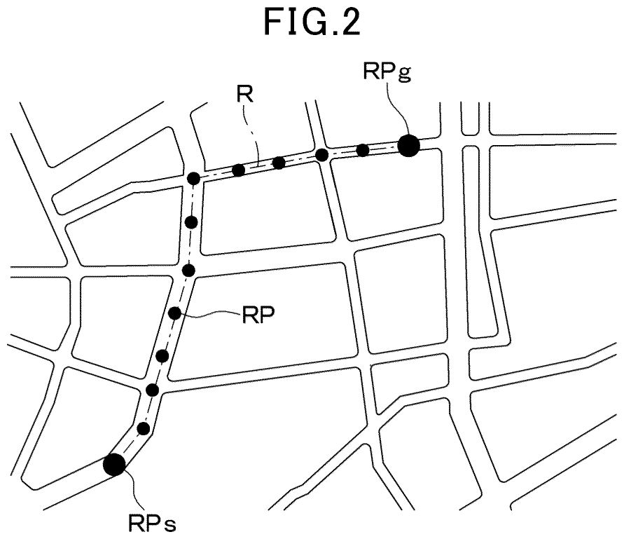

The route coordinate information 2 includes coordinate information of respective points RP on the scheduled travelling route R of the own vehicle, that is latitude-longitude information. The route coordinate information 2 can be acquired from a map data storing region of an external server of the own vehicle or a non-transitory substantial recording media (e.g. flash memory) installed on the own vehicle. The scheduled travelling route R can be acquired from the external server of the own vehicle or a navigation unit installed on the own vehicle. In FIG. 2, a point RP as a starting point of the scheduled travelling route R is indicated by a starting point RPs and a point RP as an end point of the scheduled travelling route R is indicated by an end point RPg. Note that the number of points RP and the interval therebetween on the map shown in FIG. 2 are set for simply describing the present disclosure and do not limit the contents of the present disclosure.

The route traffic information 3 indicates a traffic state of the respective points RP on the scheduled travelling route R, that is, information related to results of travelling states of one or more vehicles, which can be acquired by the external server or the like of the own vehicle. Specifically, the route traffic information 3 includes a travel time between predetermined points which can be acquired by a map information API service or the like. API is an abbreviation of Application Programming Interface. Note that the predetermined points at which the travel time can be acquired, are not limited to those in the respective sections corresponding to all of the points RP shown in FIG. 2. Specifically, for example, it is possible that only travel times are acquired for points between major points such as an intersection, a branch point, a cross-walk or points where signals are present. In this case, the points RP shown in FIG. 2 can be set, other than the major points, for internally divided points between the major points. In this case, the travel time between adjacent points RP can be calculated by multiplying the acquired travel time between the major points by a ratio of a distance between adjacent points RP to a distance between major points.

The travelling state prediction apparatus 4 is configured to predict a travelling state of the own vehicle based on at least the route coordinate information 2 and the route traffic information 3. According to the present embodiment, the travelling state prediction apparatus 4 is configured as an on-vehicle microprocessor (i.e. ECU: electronic control unit) mounted on the own vehicle. That is, the travelling state prediction apparatus 4 is provided with a processor configured of CPU or MPU and a recording media communicably connected to the processor and configured to read computer programs from the recording media and execute them, thereby accomplishing predetermined functions. The recording media includes, among various non-transitory substantial recording media such as ROM, non-volatile rewritable memory and the like, at least a ROM or a non-volatile rewritable memory. The non-volatile rewritable memory is configured such that data is rewriteable during the power being supplied, and data is held during the power being cutoff disabling rewriting-operation. The non-volatile rewritable memory is a flash memory or the like, for example. The recording media includes the above computer programs and also various data for executing the computer programs such as initial values, maps and look-up tables.

As shown in FIG. 1, the travelling state prediction apparatus 4 includes, as a functional configuration accomplished on the on-vehicle microprocessor by executing the computer programs, a moving speed calculation function 5 and a target speed determination function 6. The moving speed calculation function 5 as a moving speed acquiring unit according to the present disclosure is configured to acquire, based on the route coordinate information 2 and the route traffic information 3, speed result information which is information related to a result of the moving speed (i.e. vehicle speed) of one or more vehicles. The target speed determination function 6 as a deceleration location prediction unit predicts, based on the acquired speed result information, a deceleration location of the own vehicle. Note that ‘deceleration’ of ‘deceleration location’ includes a stoppage or a substantial stoppage according to the present disclosure. Moreover, ‘substantial stoppage’ includes a case where the vehicle speed is temporarily (e.g. within a few second) lowered from a vehicle speed during a normal travelling (e.g. higher than 10 km/h) to a slow speed at which the vehicle can immediately stop or lower, similar to a case where the vehicle passes through an intersection at which the vehicle is not required to temporarily stop. The slow speed refers to a speed of 10 km/h at which the vehicle can stop within 1 meter. The slow speed includes a very slow speed of about several km/h. In other words, ‘deceleration’ of ‘deceleration location’ refers to a temporal deceleration requiring a start acceleration or similar rise-acceleration immediately after the temporal deceleration.

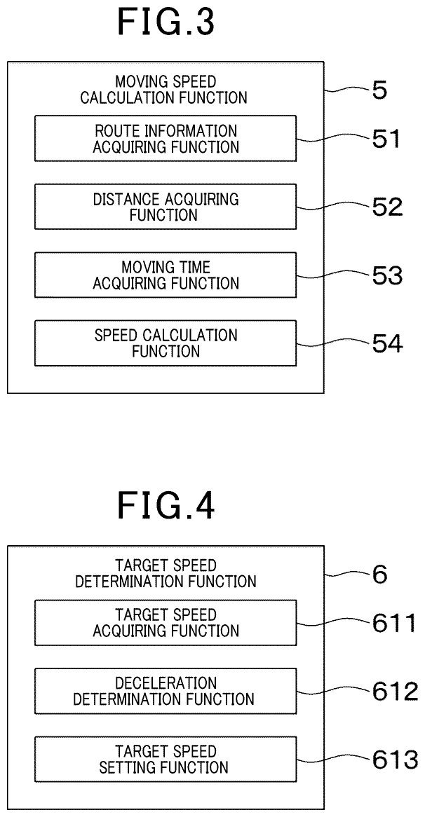

As shown in FIG. 3, according to the present embodiment, the moving speed calculation function 5 includes a route information acquiring function 51, a distance acquiring function 52, a moving speed acquiring function 53 and a speed calculation function 54. The route information acquiring function 51 acquires route coordinate information 2 from an external server outside the own vehicle. The distance acquiring function 52 is configured to acquire, based on the acquired route coordinate information 2, a distance between adjacent points RP located along the scheduled travelling route R. The moving time acquiring function 53 acquires, based on the acquired route traffic information 3, the moving time between adjacent points RP located along the schedules travelling route R. The speed calculation function 54 is configured to acquire, based on the distance between points RP acquired by the distance acquiring function 52 and the moving time between points RP acquired by the moving time acquiring function 53, a moving speed between the points RP as the speed result information. According to the present embodiment, the speed calculation function 54 calculates an average speed of at least one of result vehicle speed of the vehicle as the moving speed between the points RP.

### First Embodiment

FIG. 4 shows an overall functional configuration of the target speed determination function 6 of the travelling state prediction apparatus 4 shown in FIG. 1 according to the first embodiment. Referring to FIG. 4, according to the first embodiment, the target speed determination function 6 includes a target speed acquiring function 611, a deceleration determination function 612 and a target speed setting function 613.

The target speed acquiring function 611 acquires a temporal target speed at respective points RP on the scheduled travelling route R. According to the present embodiment, the temporal target speed is a speed limit at the respective points RP. The speed limit can be acquired from a map information API service or a navigation map data installed on the own vehicle.

The deceleration determination function 612 is configured to determine, based on the speed result information, whether each point RP is at a deceleration location, that is, whether a large degree of deceleration is present. Note that ‘large deceleration’ includes a stoppage and a substantial stop. It can be determined whether a large deceleration is present in accordance with a change in the average speed. Specifically, the determination whether a large deceleration is present can be achieved based on whether the average speed is lower than a speed threshold or whether an amount of change in the average speed is higher than a threshold change amount.

The target speed setting function 613 is configured to set the target speed of the own vehicle at each point RP based on the temporal target speed acquired by the target speed acquiring function 611 and the deceleration location determined (predicted) by the deceleration determination function 612. Specifically, the target speed setting function 613 sets the target speed to be a predetermined stoppage speed V0 when the point RP is at a deceleration point and sets the target speed to be a temporal target speed when the point RP is not at a deceleration point. The stoppage speed V0 is 0 km/h, or a predetermined speed value less than slow speed, that is, a predetermined speed value of 1 km/h-3 km/h which corresponds to very low speed. According to the present embodiment, the target speed setting function 613 sets the target speed at a start point RPs and an end point RPg to be the stoppage speed 0 km/h.

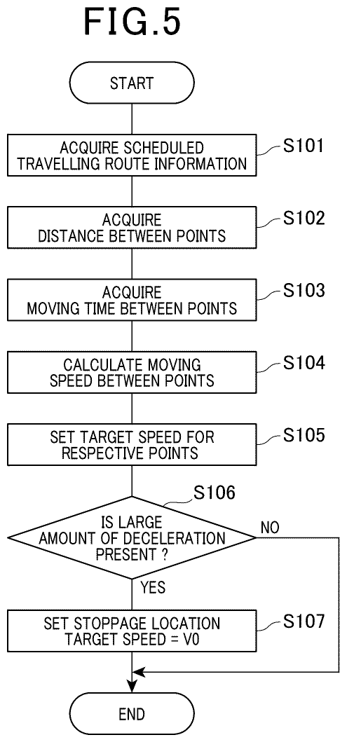

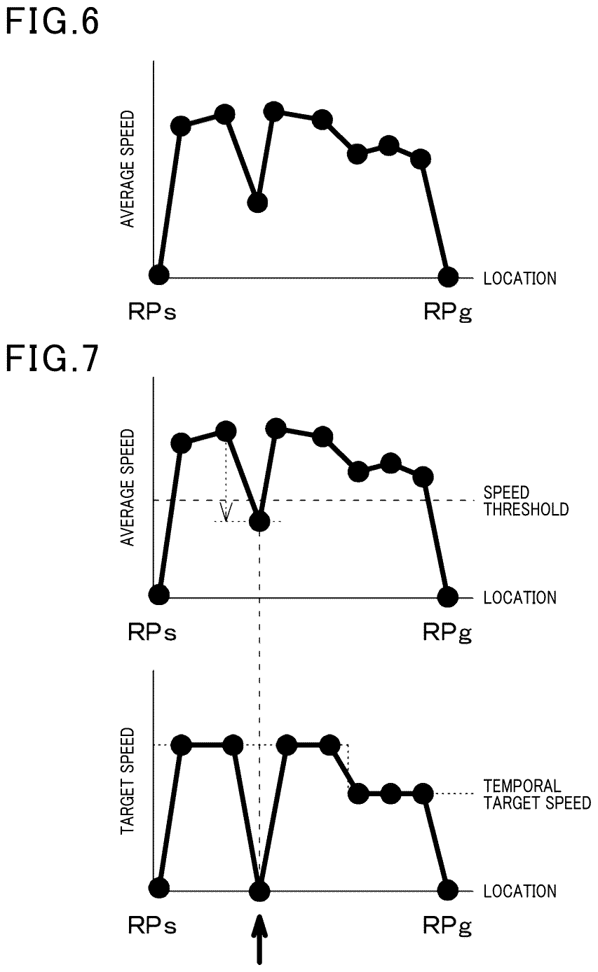

FIGS. 5 to 7 illustrate one specific example of a travelling state prediction apparatus 4 according to the present embodiment, a travelling state prediction method and a travelling state prediction program executed by the travelling state prediction apparatus 4. Hereinafter, the travelling state prediction apparatus 4 according to the present embodiment, the travelling state prediction method and the travelling state prediction program executed by the travelling state prediction apparatus 4 are referred to as ‘present embodiment’. In a flowchart shown in FIG. 5, S refers to an abbreviation of step. The same applies for flowcharts shown in other drawings. In FIG. 6 and the like, a black circle plot indicates an average speed at each point RP. However, each plot is a simple indication for simply describing the present disclosure and does not limit contents of the present disclosure. Hence, the black circuit plot is actually an outline plot and does not correspond to the arrangement of the point RP shown in FIG. 2.

At step S101, the travelling state prediction apparatus 4 acquires the scheduled route information, that is, the coordinate information of the scheduled travelling route R. Step 101 corresponds to the route information acquiring function 51. At step S102, the travelling state prediction apparatus 4 acquires a distance between adjacent points, that is, adjacent points RP on the scheduled travelling route R. Step 102 corresponds to the distance acquiring function 52. At step 103, the travelling state prediction apparatus 4 acquires the moving time between adjacent points. Step 103 corresponds to the moving time acquiring function 53. At step 104, the travelling state prediction apparatus 4 calculates an average speed as a moving speed between adjacent points. Step 104 corresponds to the speed calculation function 54. FIG. 6 is a graph showing average speed of respective points RP in the order of that shown on the scheduled travelling route R. Since the target speed at the start point RPs and the end point RPg are set to be stoppage speed, that is, 0 km/h, the average speed at the start point RPs and the end point RPg are set to be 0 km/h. The same applies to the average speed of vehicles in other drawings.

At step 105, the travelling state prediction apparatus 4 sets the target speed for the start point RPs and the end point RPg at respective points RP on the scheduled travelling road R to be 0 km/h, and sets the target speed for other points to be a temporal target speed, that is, a speed limit. Step 105 corresponds to the target speed acquiring function 611 and the target speed setting function 613. At step 106, the travelling state prediction apparatus 4 determines whether a large degree of deceleration is present at each point RP. Step 106 corresponds to the deceleration determination function 612. An upper part in FIG. 7 shows an example of a determination method for determining whether a large degree of deceleration is present at each point RP. As indicated by an arrow in FIG. 7, in the case where the average speed is lower than a speed threshold, or an amount of decrease in the average speed is higher than a threshold amount, it is possible to determine that a large degree of deceleration is present. The speed threshold or the threshold amount can be obtained by a computer simulation or an optimization experiment. The speed threshold can be set to be 10-15 km/h for example. The threshold amount can be set to be 20-30 km/h for example.

In the case where a large degree of deceleration is present (i.e. step 106=YES), the travelling state prediction apparatus 4 executes a process of step 107. At step S107, the travelling state prediction apparatus 4 sets the target speed at the point RP as a deceleration location where a large degree of deceleration is present, to be a predetermined stoppage speed V0, as a location indicated by an upward-arrow in FIG. 7. Step S107 corresponds to the target speed setting function 613. In contrast, in the case where a large degree of deceleration is not present (i.e. step 106=NO), the travelling state prediction apparatus 4 skips the process of step 107. In this case, the target speed is maintained at the speed limit as the temporal target speed.

According to the present embodiment, speed result information as information related to a result of the moving speed of one or more vehicles is acquired, and a deceleration location of the own vehicle is predicted based on the acquired speed result information. The speed result information is traffic information widely provided or information readily calculated from the traffic information. Hence, in the present embodiment, it is possible to suitably predict the travelling state of the own vehicle, specifically, a travelling speed pattern or a deceleration location of the own vehicle. Hence, according to the present embodiment, a travelling state prediction technique for the own vehicle superior in versatility can be provided.

### Second Embodiment

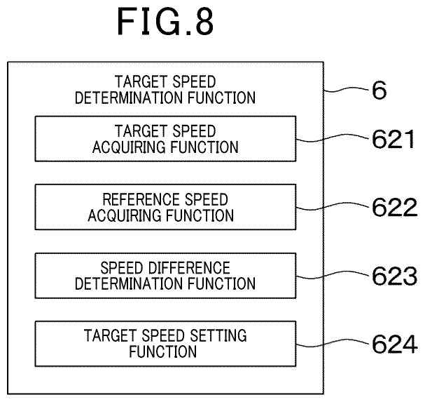

FIG. 8 shows an overall functional configuration of a target speed determination function 6 according to a second embodiment of the travelling state prediction apparatus 4 shown in FIG. 1. Referring to FIG. 8, according to the present embodiment, the target speed determination function 6 includes a target speed acquiring function 621, a reference speed acquiring function 622, a speed difference determination function 623 and a target speed setting function 624. The target speed acquiring function 621 is configured to acquire a temporal target speed at each point RP. That is, the target speed acquiring function 621 is similar to the target speed acquiring function 611 in the above-described first embodiment. Therefore, hereinafter, respective functional configurations of the reference speed acquiring function 622, the speed difference determination function 623 and the target speed setting function 624 will mainly be described.

The reference speed accruing function 622 is configured to acquire a reference speed as a moving speed of the vehicle during non-stoppage at each point RP. Note that ‘moving speed of vehicle during non-stoppage’ refers to an expected moving speed (e.g. speed limit) of the vehicle at each point RP during a normal traffic condition in which no traffic-obstruction such as traffic regulation or traffic jam occurs. The speed difference determination function 623 is configured to calculate a relationship between the reference speed and the average speed, that is, a ratio or a difference therebetween. Further, the speed difference determination function 623 is configured to determine whether the calculated ratio or difference exceeds a threshold. Specifically, the speed difference determination function 623 predicts a deceleration location to be a point RP where the calculated ratio or the difference exceeds the threshold.

The target speed setting function 624 sets, based on a determination result by the speed difference determination function 623, the target speed of the own vehicle at each point RP. Specifically, the target speed setting function 624 sets the target speed to be the predetermined stoppage speed V0 when the point RP is a deceleration location and sets the target speed to be a temporal target speed when the point RP is not a deceleration point.

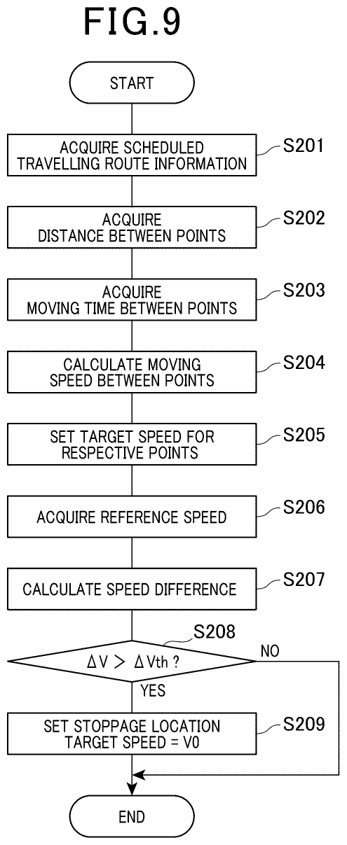

FIGS. 9 to 12 illustrate one specific example of a travelling state prediction apparatus 4 according to the present embodiment, a travelling state prediction method and a travelling state prediction program executed by the travelling state prediction apparatus 4. Note that contents of steps 201 to 204 shown in the flowchart shown in FIG. 9 are the same as those in steps 101 to 104 of the flowchart shown in FIG. 5. Hence, explanation for steps 101 to 104 in the above-described first embodiment is applied to the contents of steps 201 to 204 and processes following step 204 will be described hereinafter.

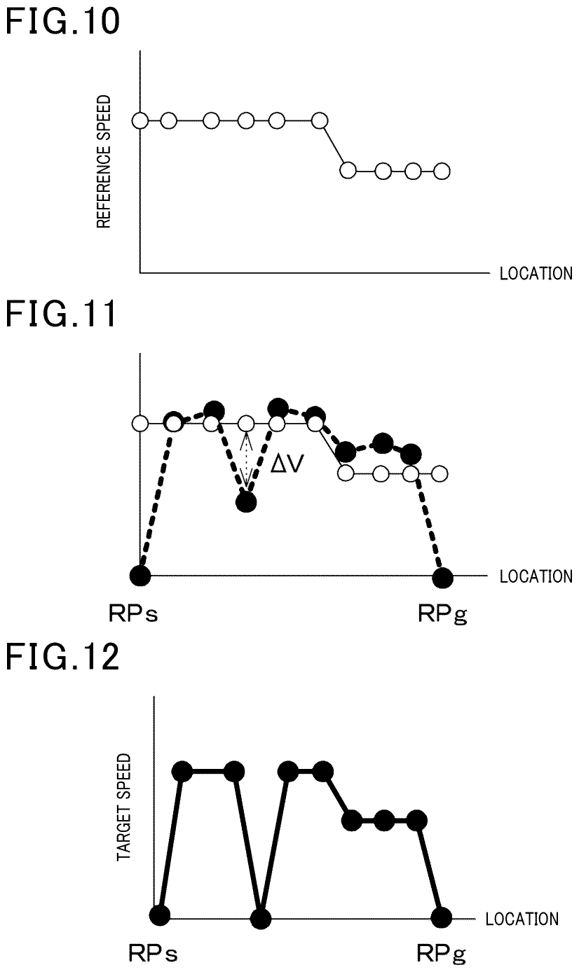

The travelling state prediction apparatus 4 sets the target speed for the start point RPs and the end point RPg at respective points RP on the scheduled travelling road R to be 0 km/h, and sets the target speed for other points to be a temporal target speed, that is, a speed limit. Step 205 corresponds to the target speed acquiring function 621 and the target speed setting function 624. At step 206, as shown in FIG. 10, the travelling state prediction apparatus 4 acquires a speed limit as a reference speed of each point RP. Step 206 corresponds to the reference speed acquiring function 622. At step 207, the travelling state prediction apparatus 4 calculates a speed difference ΔV as a difference between the reference speed and the average speed. The difference between the reference speed and the average speed is a difference between the reference speed indicated by a solid line shown in FIG. 11 and the average speed indicated by a dotted line shown in FIG. 11. At step 208, the travelling state prediction apparatus 4 determines whether the speed difference ΔV exceeds a threshold speed difference ΔVth. Step 207 and step 208 correspond to the speed difference determination function. The threshold speed difference ΔVth can be obtained by a computer simulation or an optimization experiment. The threshold speed difference ΔVth can be set to be 20-30 km/h.

When the speed difference ΔV exceeds the threshold speed difference ΔVth (i.e. step 208=YES), the travelling state prediction apparatus 4 executes a process at step 209. At step 209, the travelling state prediction apparatus 4 determines a point RP in which the speed difference ΔV exceeds the threshold speed difference ΔVth to be a deceleration point, and sets the target speed of the point RP as the deceleration point to be the stoppage speed V0. Step 209 corresponds to the target speed setting function 624. In contrast, when the speed difference ΔV is less than or equal to the threshold speed difference ΔVth (i.e. step 208=NO), the travelling state prediction apparatus 4 skips the process of step 209. In this case, the target speed is maintained at the speed limit as the temporal target speed. Thus, as shown in FIG. 12, the travelling state prediction apparatus 4 sets, in accordance with the processing result of step 205 and the determination result of step 208, the final target speed at the respective points RP.

The present embodiment predicts the deceleration point based on a relationship between the reference speed as the moving speed during non-stoppage and the average speed. Thus, the deceleration location such as stoppage location can be accurately predicted. Hence, the present embodiment is able to provide a travelling state prediction technique of an own vehicle having superior versatility and prediction accuracy.

### Third Embodiment

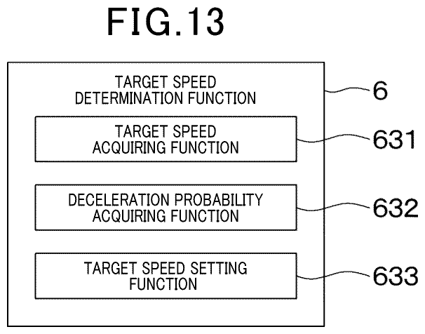

FIG. 13 shows an overall functional configuration of a target speed determination function 6 in the travelling state prediction apparatus 4 shown in FIG. 1 according to the third embodiment. Referring to FIG. 13, according to the present embodiment, the target speed determination function 6 includes the target speed acquiring function 631, a deceleration probability acquiring function 632 and a target speed setting function 633. The target speed acquiring function 631 is configured to acquire a temporal target speed at each point RP. That is, the target speed acquiring function 621 is similar to the target speed acquiring function 611 in the above-described first embodiment. Therefore, hereinafter, respective functional configurations of the deceleration probability acquiring function 632 and the target speed setting function 633 will mainly be described.

The deceleration probability acquiring function 632 is configured to acquire a deceleration probability of the vehicle at each point RP. The deceleration probability refers to an occurrence probability of a stoppage or a substantial stoppage of the vehicle at respective points RP during a normal traffic condition in which no traffic-obstruction such as traffic regulation or traffic jam occurs. The deceleration probability can be obtained based on a recorded vehicle travelling state of each point RP. Specifically, the deceleration probability can be obtained in accordance with history information of a result of the moving speed at respective points RP of one or more vehicles. More specifically, a speed-change parameter is defined as a change in the average speed, that is, an amount of decrease of the average speed, or a relationship (e.g. difference) between the reference speed as a moving speed during a non-stoppage and the average speed. A statistical process is applied to a correlation between a speed-change parameter and a state of occurrence of a stoppage or substantial stoppage of the vehicle, thereby obtaining a map or a formula indicating a relationship between the speed-change parameter and the deceleration probability. The map or the formula can be calculated in a server or the like located outside the own vehicle for example. The map or the formula is read from the server or like at an appropriate timing, thereby being utilized in the own vehicle. Moreover, the deceleration probability acquiring function 632 is able to acquire, based on the map or the formula and the speed-change parameter at respective points RP, the deceleration probability at respective points RP.

Also, the deceleration probability acquiring function 632 is configured to determine whether the deceleration probability of the vehicle at each point RP is lower than a probability threshold. In other words, the deceleration probability acquiring function 632 determines whether each point RP is at a deceleration location. Then, the target speed setting function 633 sets the target speed of the own vehicle at each point RP based on the determination result of the deceleration probability acquiring function 632. Specifically, the target speed setting function 633 sets the target speed to be a stoppage speed V0 when the point RP is at a deceleration point and sets the target speed to be a temporal target speed when the point RP is not at a deceleration point.

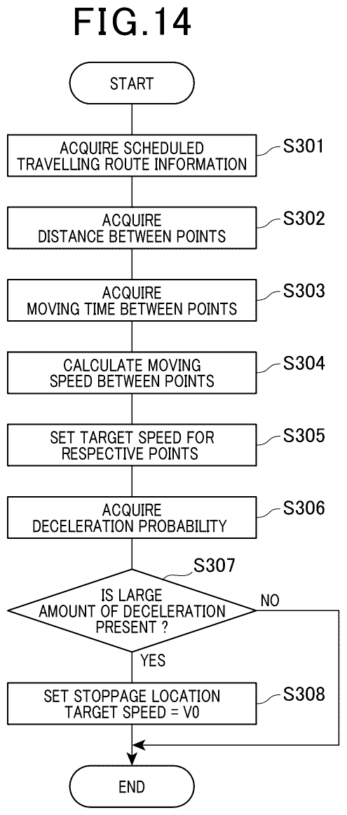

FIGS. 14 to 17 illustrate one specific example of a travelling state prediction apparatus 4 according to the present embodiment, a travelling state prediction method and a travelling state prediction program executed by the travelling state prediction apparatus 4. Note that contents of steps 301 to 304 shown in the flowchart shown in FIG. 14 are the same as those in steps 101 to 104 of the flowchart shown in FIG. 5. Hence, explanation for steps 101 to 104 in the above-described first embodiment is applied to the contents of steps 301 to 304 and processes following step 304 will be described hereinafter.

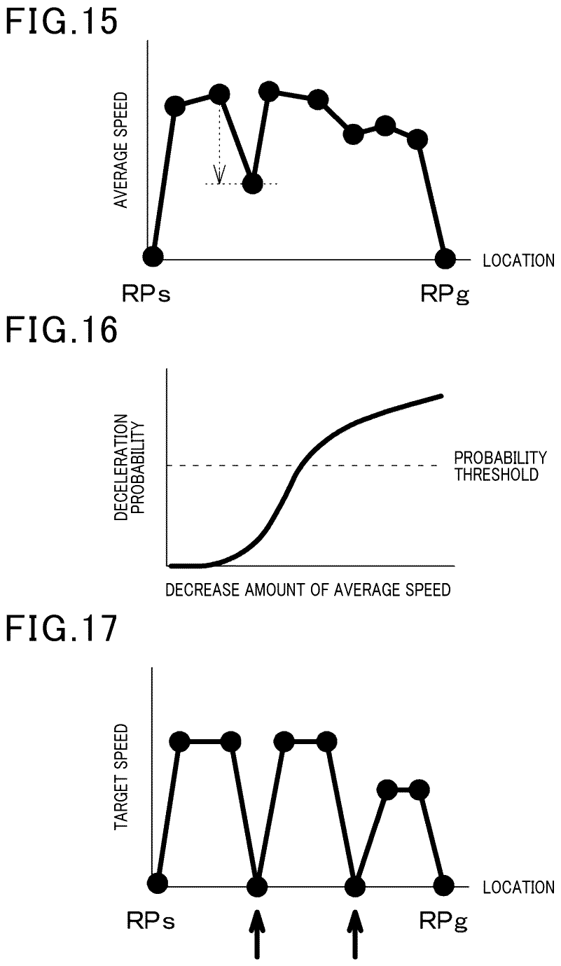

At step 305, the travelling state prediction apparatus 4 sets the target speed for the start point RPs and the end point RPg at respective points RP on the scheduled travelling road R to be 0 km/h, and sets the target speed for other points to be a temporal target speed, that is, a speed limit. Step 305 corresponds to the target speed acquiring function 631 and the target speed setting function 633. At step 306, the travelling state prediction apparatus 4 acquires a deceleration probability at each point RP. According to the present specific example, as shown FIG. 15, the deceleration probability is calculated using an amount of decrease of the average speed. At step 307, the travelling state prediction apparatus 4 determines whether a large degree of deceleration is present at each point RP. That is, the travelling state prediction apparatus 4 determines, based on the map indicating a relationship between the deceleration probability and the amount of decrease in the average speed shown in FIG. 16, whether the deceleration probability exceeds the probability threshold at each point RP. Step 306 and step 307 correspond to deceleration probability acquiring function 632.

In the case where the deceleration probability exceeds the probability threshold (i.e. step 307=YES), the travelling state prediction apparatus 4 executes a process at step 308. At step 308, the travelling state prediction apparatus 4 utilizes a point RP of which the deceleration probability exceeds the probability threshold to be a deceleration location, and sets the target speed of the point RP as the deceleration location to be a predetermined stoppage speed V0. Step 308 corresponds to the target speed setting function 633. In contrast, when the deceleration probability does not exceed the probability threshold (i.e. step 307=NO), the travelling state prediction apparatus 4 skips the process at step 308. In this case, the target speed is maintained at the speed limit as a temporal target speed. Thus, as shown in FIG. 17, the travelling state prediction apparatus 4 sets, in accordance with the processing result of step 305 and the processing result of step 308 based on the determination result of step 307, the final target speed at the respective points RP.

### Modification Example

The present disclosure is not limited to the above-described embodiments and specific examples. Hence, the above-described embodiments may be appropriately modified. Hereinafter, typical modification examples will be described. In the following modification examples, configurations different from those in the above-described embodiments will mainly be described. Further, the same reference symbols are applied to the same or equivalent configurations between the above-described embodiments or modification examples. Therefore, in the following modification examples, explanations of the above-described embodiments will be applied to constituents having the same reference symbols as those in the above-described embodiments unless technical inconsistency or any additional explanation is present.

The present disclosure is not limited to specific use or an apparatus configuration described in the above-described embodiments. That is, for example, the travelling state prediction apparatus 4 may be utilized for various purposes including a prediction of a vehicle-travelling energy or a battery remaining capacity (i.e. SOC). Further, a part of or some of configurations of the travelling state prediction apparatus 4 may be provided in a server outside the own vehicle. Specifically, for example, the moving speed calculation function 5 may be provided in the server outside the own vehicle.

Moreover, a part of or some of configurations of the travelling state prediction apparatus 4 may be a digital circuit configured to be capable of accomplishing the above-described functions or operations, for example, it may be configured of ASIC (application specific integrated circuit) or FPGA (field programable gate array). In the travelling state prediction apparatus 4, on-vehicle microprocessor part and a digital circuit part may coexist.

Note that programs according to the present disclosure capable of executing various operations, procedure or processes described in the above embodiments may be downloaded or upgraded via a V2X communication. V2X is an abbreviation of vehicle to X. Further, the programs may be downloaded or upgraded via terminal equipment provided in a manufacturing factory, a maintenance facility, a dealer of the own vehicle and the like. The programs may be stored into a memory card, an optical disk, a magnetic disk and the like.

The above-described respective functional configurations and processes may be accomplished by a dedicated computer constituted of a processor and a memory programmed to execute one or more functions embodied by computer programs. Alternatively, the above-described respective functional configurations and processes may be accomplished by a dedicated computer provided by a processor configured of one or more dedicated hardware logic circuits. Further, the above-described respective functional configurations and processes may be accomplished by one or more dedicated computer where a processor and a memory programmed to execute one or more functions, and a processor configured of one or more hardware logic circuits are combined. Furthermore, the computer programs may be stored, as instruction codes executed by the computer, into a computer readable non-transitory tangible recording media. That is, the above-described respective functional configurations and processes may be expressed by computer programs including processes for achieving the above-described respective functional configurations and processes or a computer readable non-transitory tangible recording media that stores the programs.

The present disclosure is not limited to specific operation modes described in the above-described embodiments. Specifically, for example, all of points RP may be acquired as traffic information which is the moving time between adjacent points RP. Further, the order of executing the process at step 102 and the process at step 103 shown in FIG. 5 may be opposite or these processes may be simultaneously executed. Moreover, various graphs shown in FIG. 6 and the like are provided to simply describing the present disclosure and do not limit the contents of the present disclosure. Further, a relationship between each functional configuration and corresponding step in the flowchart may be appropriately changed. In other words, for example, step 208 may correspond to the target speed setting function 624. Further, the stoppage speed V0 may be changed between types of stoppage locations. Specifically, for example, the stoppage speed V0 may be set to be V0=0 km/h for the stoppage location at which the vehicle is required to temporarily stop, and may be set to be V0>0 km/h for the stoppage location at which the vehicle is not required to strop. For a case of an intersection having no signals where a temporary stop is required depending on the situation, the stoppage speed V0 may be set to be V0>0 km/h. Also, for the stoppage location where the stoppage speed is V0≠0 km/h, the stoppage speed may be changed depending on respective traffic situations.

Note that terms used in this specification such as ‘acquisition, ‘calculation’, ‘estimation’, ‘detection’, ‘determination’ and similar terms may be appropriately exchanged with each other as long as no technical inconsistency is present. Also, ‘detection’ and ‘extraction’ may be appropriately exchanged with each other as long as no technical inconsistency is present. Further, ‘exceeding threshold’ and ‘larger than or equal to threshold’ may be appropriately exchanged with each other as long as no technical inconsistency is present. The same applies to ‘less than threshold’ and ‘smaller than or equal to threshold’.

In the above-described embodiments, elements constituting the embodiments are not necessarily required except that elements are clearly specified as necessary or theoretically necessary. Even in the case where numeric values are mentioned in the above-described embodiments, such as the number of constituents, numeric values, quantity, range or the like, it is not limited to the specific values unless it is specified as necessary or theoretically limited to specific numbers. In the case where materials, shapes, directions, positional relationships and the like are mentioned for the constituents in the above-described embodiments, it is not limited to the material, the directions, the shapes and positional relationships except that they are clearly specified or theoretically limited to specific material, shapes, directions, positional relationships and the like.

The modification examples are not limited to the above-described examples. For example, all of or a part of one example in a plurality of specific examples may be mutually combined with all of or a part of another one example as long as no technical inconsistency is present. The number of combinations may not be specifically limited. Similarly, all of or a part of one example in a plurality of modification examples may be mutually combined with all of or a part of another one example as long as no technical inconsistency is present. Further, all of or a part of the specific examples may be mutually combined with all of or a part of the above-described modification examples as long as no technical inconsistency is present.

### Configurations

As is apparent from the above-described embodiments and modification examples, the present specification discloses at least the following configurations.

### [Configuration 1-1]

A travelling state prediction apparatus (4) that predicts a travelling state of an own vehicle, comprising:
a moving speed acquiring unit (5) that acquires speed result information as information related to a result of a moving speed of one or more vehicles; and
a deceleration location prediction unit (6) that predicts a deceleration location of the own vehicle based on the acquired speed result information.

### [Configuration 1-2]

The travelling state prediction apparatus according to configuration 1-1, wherein
the speed result information is an average speed.

### [Configuration 1-3]

The travelling state prediction apparatus according to configuration 1-2, wherein
the deceleration location prediction unit predicts the deceleration location based on a change in the average speed.

### [Configuration 1-4]

The travelling state prediction apparatus according to configuration 1-3, wherein
the deceleration location prediction unit predicts, based on whether the average speed is lower than a speed threshold or whether an amount of change in the average speed is higher than a threshold change amount, the deceleration location.

### [Configuration 1-5]

The travelling state prediction apparatus according to configuration 1-2, wherein
the travelling state prediction apparatus includes a reference speed acquiring unit (622) that acquires a reference speed which is a moving speed of a vehicle during non-stoppage; and
the deceleration location prediction unit predicts the deceleration location based on a relationship between the reference speed and the average speed.

### [Configuration 1-6]

The travelling state prediction apparatus according to configuration 1-5, wherein
the relationship is a ratio or a difference therebetween.

### [Configuration 1-7]

The travelling state prediction apparatus according to configuration 1-2, wherein
travelling state prediction apparatus includes a deceleration probability acquiring unit (632) that acquires a deceleration probability calculated based on a change in the average speed or a relationship between a reference speed which is a moving speed of a vehicle during non-stoppage and the average speed; and
the deceleration location prediction unit predicts the deceleration location based on the deceleration probability.

### [Configuration 1-8]

The travelling state prediction apparatus according to configuration 1-7, wherein
the deceleration location prediction unit predicts the deceleration location based on whether the deceleration probability is lower than a probability threshold.

### [Configuration 1-9]

The travelling state prediction apparatus according to configuration 1-7 or 1-8, wherein
the deceleration probability is calculated based on history information of a result of moving speed of one or more vehicles at a predetermined location.

### [Configuration 2-1]

A method of predicting a travelling state of an own vehicle comprising:
acquiring speed result information as information related to a result of a moving speed of one or more vehicles; and
predicting a deceleration location of the own vehicle based on the acquired speed result information.

### [Configuration 2-2]

The method according to configuration 2-1, wherein
the speed result information is an average speed.

### [Configuration 2-3]

The method according to configuration 2-2, wherein
the method predicts the deceleration location based on a change in the average speed.

### [Configuration 2-4]

The method according to configuration 2-3, wherein
the method predicts, based on whether the average speed is lower than a speed threshold or whether an amount of change in the average speed is higher than a threshold change amount, the deceleration location.

### [Configuration 2-5]

The method according to configuration 2-2, wherein
the method acquires a reference speed which is a moving speed of a vehicle during non-stoppage; and predicts the deceleration location based on a relationship between the reference speed and the average speed.

### [Configuration 2-6]

The method according to configuration 2-5, wherein
the relationship is a ratio or a difference therebetween.

### [Configuration 2-7]

The method according to configuration 2-2, wherein
the method acquires a deceleration probability calculated based on a change in the average speed or a relationship between a reference speed which is a moving speed of a vehicle during non-stoppage and the average speed; and predicts the deceleration location based on the deceleration probability.

### [Configuration 2-8]

The method according to configuration 2-7, wherein
the method predicts the deceleration location based on whether the deceleration probability is lower than a probability threshold.

### [Configuration 2-9]

The method according to configuration 2-7 or 2-8, wherein
the method calculates the deceleration probability based on history information of a result of moving speed of one or more vehicles at a predetermined location.

### [Configuration 3-1]

A travelling state prediction program executed by a travelling state prediction apparatus (4) that predicts a travelling state of an own vehicle, comprising:
a moving speed acquiring process that acquires speed result information as information related to a result of a moving speed of one or more vehicles; and
a deceleration location prediction process that predicts a deceleration location of the own vehicle based on the acquired speed result information.

### [Configuration 3-2]

The program according to configuration 3-1, wherein
the speed result information is an average speed.

### [Configuration 3-3]

The program according to configuration 3-2, wherein
the deceleration location is predicted based on a change in the average speed in the deceleration location prediction process.

### [Configuration 3-4]

The program according to configuration 3-3, wherein
the deceleration location is predicted based on whether the average speed is lower than a speed threshold or whether an amount of change in the average speed is higher than a threshold change amount in the deceleration location prediction process.

### [Configuration 3-5]

The program according to configuration 3-2, wherein
the program includes a reference speed acquiring process that acquires a reference speed which is a moving speed of a vehicle during non-stoppage; and
the deceleration location is predicted based on a relationship between the reference speed and the average speed in the deceleration location prediction process

### [Configuration 3-6]

The program according to configuration 3-5, wherein
the relationship is a ratio or a difference therebetween.

### [Configuration 3-7]

The program according to configuration 3-2, wherein
the program includes a deceleration probability acquiring process that acquires a deceleration probability calculated based on a change in the average speed or a relationship between a reference speed which is a moving speed of a vehicle during non-stoppage and the average speed; and the deceleration location is predicted based on the deceleration probability in the deceleration location prediction process.

### [Configuration 3-8]

The program according to configuration 3-7, wherein
the deceleration location is predicted based on whether the deceleration probability is lower than a probability threshold in the deceleration probability acquiring process.

### [Configuration 3-9]

The program according to configuration 3-7 or 3-8, wherein
the deceleration probability is calculated based on history information of a result of moving speed of one or more vehicles at a predetermined location.

### Conclusion

The present disclosure has been accomplished in light of the above-exemplified circumstances. The present disclosure provides a travelling state prediction technique of an own vehicle having a superior versatility.

A travelling state prediction apparatus (4) is configured to predict a travelling state of an own vehicle. A travelling state prediction apparatus according to a first aspect is provided with a moving speed acquiring unit (5) that acquires speed result information as information related to a result of a moving speed of one or more vehicles; and a deceleration location prediction unit (6) that predicts a deceleration location of the own vehicle based on the acquired speed result information. A travelling state prediction method according to a tenth aspect is a method of predicting a travelling state of the own vehicle accomplished by acquiring speed result information as information related to a result of a moving speed of one or more vehicles and predicting a deceleration location of the own vehicle based on the acquired speed result information. A travelling state prediction program according to an eleventh aspect is a computer program executed by a travelling state prediction apparatus (4) that predicts a travelling state of an own vehicle, including a moving speed acquiring process that acquires speed result information as information related to a result of a moving speed of one or more vehicles; and a deceleration location prediction process that predicts a deceleration location of the own vehicle based on the acquired speed result information.

The above-described configurations and method acquires speed result information as information related to a result of a moving speed of one or more vehicles and predicts a deceleration location of the own vehicle based on the acquired speed result information. The speed result information can be calculated based on traffic information widely provided or information readily calculated from the traffic information. Hence, according to the above-described configurations and method, the travelling state of the own vehicle can favorably be predicted based on the traffic information widely provided. Therefore, according to the above-described configurations and method, a travelling state prediction technique of an own vehicle having a superior versatility can be provided.

What is claimed is:

1. A travelling state prediction apparatus that predicts a travelling state of an own vehicle, comprising:
a moving speed acquiring unit that acquires speed result information as information related to a result of a moving speed of one or more vehicles; and
a deceleration location prediction unit that predicts a deceleration location of the own vehicle based on the acquired speed result information.

2. The travelling state prediction apparatus according to claim 1, wherein
the speed result information is an average speed.

3. The travelling state prediction apparatus according to claim 2, wherein
the deceleration location prediction unit predicts the deceleration location based on a change in the average speed.

4. The travelling state prediction apparatus according to claim 3, wherein
the deceleration location prediction unit predicts, based on whether the average speed is lower than a speed threshold or whether an amount of change in the average speed is higher than a threshold change amount, the deceleration location.

5. The travelling state prediction apparatus according to claim 2, wherein
the travelling state prediction apparatus includes a reference speed acquiring unit that acquires a reference speed which is a moving speed of a vehicle during non-stoppage; and
the deceleration location prediction unit predicts the deceleration location based on a relationship between the reference speed and the average speed.

6. The travelling state prediction apparatus according to claim 5, wherein
the relationship is a ratio or a difference therebetween.

7. The travelling state prediction apparatus according to claim 2, wherein
travelling state prediction apparatus includes a deceleration probability acquiring unit that acquires a deceleration probability calculated based on a change in the average speed or a relationship between a reference speed which is a moving speed of a vehicle during non-stoppage and the average speed; and
the deceleration location prediction unit predicts the deceleration location based on the deceleration probability.

8. The travelling state prediction apparatus according to claim 7, wherein
the deceleration location prediction unit predicts the deceleration location based on whether the deceleration probability is lower than a probability threshold.

9. The travelling state prediction apparatus according to claim 7, wherein
the deceleration probability is calculated based on history information of a result of moving speed of one or more vehicles at a predetermined location.

10. A method of predicting a travelling state of an own vehicle comprising:
acquiring speed result information as information related to a result of a moving speed of one or more vehicles; and
predicting a deceleration location of the own vehicle based on the acquired speed result information.

11. A travelling state prediction program executed by a travelling state prediction apparatus that predicts a travelling state of an own vehicle, comprising:
a moving speed acquiring process that acquires speed result information as information related to a result of a moving speed of one or more vehicles; and
a deceleration location prediction process that predicts a deceleration location of the own vehicle based on the acquired speed result information.
